(19) United States
(12) Patent Application Publication
(10) Pub. No.: US 2016/0269380 A1
(43) Pub. Date: Sep. 15, 2016

(54) VPN COMMUNICATION TERMINAL COMPATIBLE WITH CAPTIVE PORTALS, AND COMMUNICATION CONTROL METHOD AND PROGRAM THEREFOR

(71) Applicant: Hitachi Solutions, Ltd., Tokyo (JP)

(72) Inventor: Hiroyuki KISHIDA, Tokyo (JP)

(21) Appl. No.: 15/013,260

(22) Filed: Feb. 2, 2016

(30) Foreign Application Priority Data
Mar. 10, 2015 (JP) 2015-047094

(51) Int. Cl. H04L 29/06; H04L 29/08

(52) U.S. Cl. CPC H04L 63/08; H04L 63/0272; H04L 67/02

(57) ABSTRACT

Provided is, in a scene where a VPN communication terminal, which has a function of restricting its communication in a network outside a company to communication with a VPN authentication server, connects to the Internet via an access point that complies with a wireless LAN meeting the captive portal specifications, a mechanism capable of performing captive portal authentication independently of vendors while preventing leakage of information. A VPN communication terminal has mounted thereon (1) a functional unit configured to autonomously monitor the connection status of the terminal with the Internet, (2) a functional unit configured to allow communication of a browser program only when the terminal is not determined to be connected to the Internet; and (3) a functional unit configured to restrict network communication of the terminal to only communication with the VPN authentication server only when the terminal is determined to be connected to the Internet.

### CLAIM OF PRIORITY

The present application claims priority from Japanese patent application JP 2015-047094 filed on Mar. 10, 2015, the content of which is hereby incorporated by reference into this application.

### BACKGROUND

1. Technical Field

The present invention relates to a VPN (Virtual Private Network) communication terminal that is compatible with captive portals, and a VPN communication control method and a program that are executed on such terminal.

2. Background Art

Some stations or hotels, for example, provide wireless LAN (Local Area Network) access points in their spaces. In such a space, a terminal is connected to the Internet through wireless LAN communication with the access point. By the way, some wireless LAN access points require authentication to be performed with a browser program for identification purposes before establishing an Internet connection. In the present specification, an authentication website that performs such authentication shall be referred to as a “captive portal website,” and the specifications thereof shall be referred to as “captive portal specifications.” At an access point that complies with the captive portal specifications, an Internet connection is not established unless authentication on a captive portal website is completed.

By the way, the Applicant has already proposed a mechanism for, in order to avoid circumstances in which information in a terminal may leak via a network outside a company, restricting communication of the terminal, which is located in a network outside the company, to communication with a VPN authentication server that is managed by the company (Patent Document 1).

### RELATED ART DOCUMENTS

### Patent Documents

Patent Document 1: JP 2013-38716 A

### SUMMARY

By the way, a terminal that is compatible with the mechanism described in Patent Document 1 cannot be used in a space where an access point that complies with a wireless LAN meeting the captive portal specifications is provided as described above. This is because, with the mechanism described in Patent Document 1, communication of a browser program with a captive portal authentication server is prohibited, and authentication on a captive portal website is thus not allowed. Without authentication, an Internet connection is not established, and consequently, a VPN authentication server on the Internet cannot be accessed.

In order to allow a terminal that adopts the mechanism described in Patent Document 1 to connect to the Internet via an access point that complies with a wireless LAN meeting the captive portal specifications, one of processes (1) and (2) shown below is necessary.

(1) Allow communication of a browser program.

(2) Identify a captive portal website whose format differs from vendor to vendor, and allow network communication if the communication destination is a captive portal website.

By the way, if communication of a browser program is allowed, it becomes possible to access not only a captive portal website but also any websites on the Internet. Thus, it is impossible to prevent leakage of information from the terminal. Meanwhile, communication with a captive portal website should be identified based on the format of each vendor. However, it is not realistic to install the settings for the format of each vendor on all terminals and always manage the settings up-to-date.

Thus, the inventor provides, in a scene where a VPN communication terminal, which has a function of restricting its communication in a network outside a company to communication with a VPN authentication server, connects to the Internet via an access point that complies with a wireless LAN meeting the captive portal specifications, a mechanism that is capable of performing captive portal authentication independently of vendors while preventing leakage of information from the terminal.

In order to solve the aforementioned problems, a VPN communication terminal that is a representative invention includes (1) a functional unit configured to autonomously monitor the connection status of the terminal with the Internet, (2) a functional unit configured to allow communication of a browser program only when the terminal is not determined to be connected to the Internet (that is, before authentication on a captive portal website is completed); and (3) a functional unit configured to restrict network communication of the terminal to only communication with a VPN authentication server only when the terminal is determined to be connected to the Internet (that is, after authentication on the captive portal website is completed).

According to the present invention, even in an environment where the destination of network communication is restricted to a VPN authentication server, it is possible to perform authentication on a captive portal website without identifying a captive portal website for each vendor while surely preventing leakage of information from the terminal. Other problems, configurations, and advantages will become apparent from the following description of embodiments.

### BRIEF DESCRIPTION OF THE DRAWINGS

FIG. 1 is a configuration diagram of a network system in accordance with an embodiment.

FIG. 2 is a diagram illustrating a functional block configuration of a user terminal.

FIG. 3 is a diagram illustrating a network path before authentication on a captive portal website is performed.

FIG. 4 is a diagram illustrating a network path while authentication on a captive portal website is performed.

FIG. 5 is a diagram illustrating a network path immediately after authentication on a captive portal website succeeded.

FIG. 6 is a diagram illustrating a network path after authentication on a captive portal website succeeded.

### DETAILED DESCRIPTION OF THE EMBODIMENT(S)

Hereinafter, embodiments of the preset invention will be described with reference to the accompanying drawings. The embodiments of the present invention are not limited to those described below, and a variety of modifications is possible within the spirit and scope of the present invention.

### (1) Basic Concept

A VPN communication terminal described below is characterized by having mounted thereon a mechanism of autonomously/dynamically monitoring the Internet connection status, and allowing communication of a browser program only when the terminal is not connected to the Internet yet before authentication on a captive portal website, thereby realizing authentication on the captive portal website independently of vendors and preventing leakage of information from the terminal to the Internet. It should be noted that such a mechanism is based on the premise that a dedicated HTTP (Hypertext Transfer Protocol) server is put on the Internet to autonomously/dynamically monitor the Internet connection status.

When both the IP address that has resolved the name of the dedicated HTTP server and HTTP data that has been exchanged through HTTP communication are correct, the VPN communication terminal determines that the terminal is connected to the Internet; otherwise, the VPN communication terminal determines that the terminal is not connected to the Internet. It should be noted that such monitoring is performed by periodically or randomly polling the dedicated HTTP server from the VPN communication terminal (i.e., by detecting if there is a response or not).

If there is a response from the dedicated HTTP server and it is thus determined that the terminal is connected to the Internet, the VPN communication terminal restricts its communication to communication with the VPN authentication server as with the technique described in Patent Document 1, thereby preventing leakage of information from the terminal to the Internet. If there is no response from the dedicated HTTP server and it is thus determined that the terminal is not connected to the Internet, the VPN communication terminal regards that authentication on a captive portal website is not performed yet, and thus allows communication of a browser program so as to allow authentication on the captive portal website. As the communication performed herein is the communication of a browser program, it is not necessary to identify the format of a captive portal website for each vendor. At this point, the VPN communication terminal is not connected to the Internet. Thus, even when communication of the browser program is allowed, there is no possibility that information in the terminal may leak to the Internet.

### (2) Embodiment 1

### (2-1) Entire Configuration

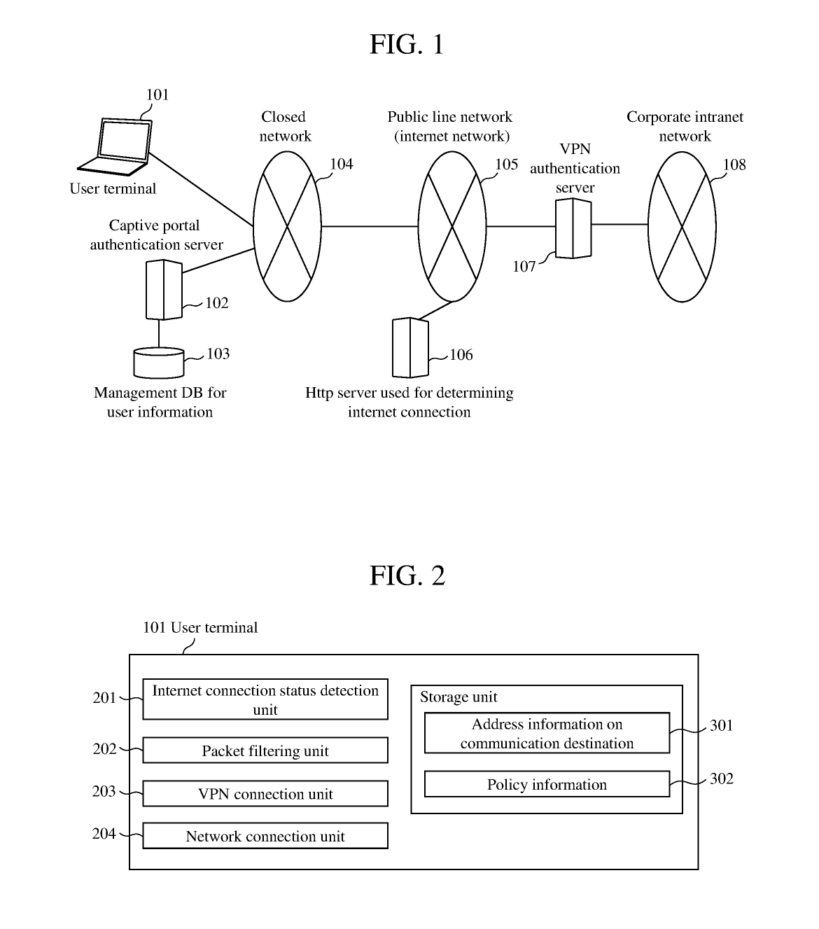

FIG. 1 shows an example of a network system constructed using a VPN communication terminal that adopts the aforementioned mechanism. A closed network 104 is a network constructed in a station, a hotel, or the like, and a captive portal authentication server 102 is connected thereto. The captive portal authentication server 102 includes a captive portal website (i.e., an authentication website) and a management DB 103 for user information for use in authentication.

A user terminal 101 is a VPN communication terminal that is allowed to communicate with only a VPN authentication server 107 on the Internet, and is connected to the closed network 104 when the terminal is located in the communication range of an access point (not shown) that complies with a wireless LAN meeting the captive portal specifications. When the user terminal 101 that is connected to the closed network 104 (and is not connected to a public line network 105 at this stage) attempts to refer to a website on the Internet via a browser program, the communication is redirected to a captive portal website by the captive portal authentication server 102. At this time, the user of the user terminal 101 is required to input user information and the like in response to a request from the captive portal website.

A user terminal 101 that is not compatible with the mechanism described in this embodiment is not allowed to communicate with the captive portal website via a browser program unlike the communication described above. Therefore, such a user terminal 101 cannot input user information and the like via a browser screen. However, the user terminal 101 that is compatible with the mechanism described in this embodiment is allowed to communicate with the captive portal website via a browser program while the user terminal 101 is not connected to the Internet. Thus, the captive portal authentication server 102 checks the input information against information registered in the management DB 103 for user information to confirm the user. If the input information matches the registered information, the captive portal authentication server 102 frees a line connecting to the public line network (i.e., Internet network) 105 for the relevant user terminal 101. Consequently, it becomes possible for the user terminal 101 to use the public line network 105 and thus access the VPN authentication server 107.

A HTTP server 106 is connected to the public line network 105 to determine whether or not the user terminal 101 is connected to the public line network 105. The IP address of the HTTP server 106 is already known and is stored in the user terminal 101 in advance as described below. A corporate intranet network 108 is connected to a distal end of the VPN authentication server 107 seen from the public line network 105, and only the user terminal 101 that has been authenticated by the VPN authentication server 107 can access a variety of information in the corporate intranet network 108.

### (2-2) Functional Block Configuration of User Terminal 101

FIG. 2 shows the functional block configuration of the user terminal 101. Among the functions shown in FIG. 2, the functions of units other than a storage unit may be implemented as either hardware or programs that are executed by a computer (i.e., CPU/MPU). The user terminal 101 in accordance with this embodiment is assumed to be a smartphone or a tablet terminal, for example. Needless to say, the user terminal 101 is not limited to such terminals, and may also be a laptop computer terminal or a dedicated portable terminal. Though not shown, the user terminal 101 has mounted thereon a variety of functional devices that are mounted on smartphones and the like. For example, the user terminal 101 has mounted thereon a CPU, a memory, an input instruction device (i.e., a touch panel), a GPS (Global Positioning System) receiving device, a wireless communication device that complies with Wi-Fi (trademark), a magnetic sensor, an acceleration sensor, and the like.

An Internet connection status detection unit 201 is a program for monitoring the status of communication with a specific IP address based on address information 301 on the communication destination stored in the storage unit, and determining that the user terminal 101 is connected to the Internet if communication is possible. The specific IP address herein is the IP address of the HTTP server 106.

A packet filtering unit 202 is a device or a program for, based on policy information 302 stored in the storage unit, implementing communication control by, for example, allowing or rejecting communication with only a device that has a specific IP address. In this embodiment, the packet filtering unit 202 allows communication with only the IP address of the HTTP server 106 until an Internet connection is confirmed, and allows communication with the IP address of the VPN authentication server 107 after an Internet connection is confirmed. A VPN connection unit 203 is a device or a program for connecting to the VPN authentication server 107 to execute a process necessary for VPN communication. A network connection unit 204 is a device that connects to a network to perform communication, and corresponds to a NIC (network interface card), for example.

The storage unit stores the address information 301 on the communication destination and the policy information 302. The address information 301 on the communication destination is information on the IP address of a device or an apparatus, which is the communication destination, for detecting the Internet connection status. The policy information 302 is information that contains conditions to be applied to communication control of allowing or prohibiting communication when executing VPN communication.

### (2-3) Communication Control

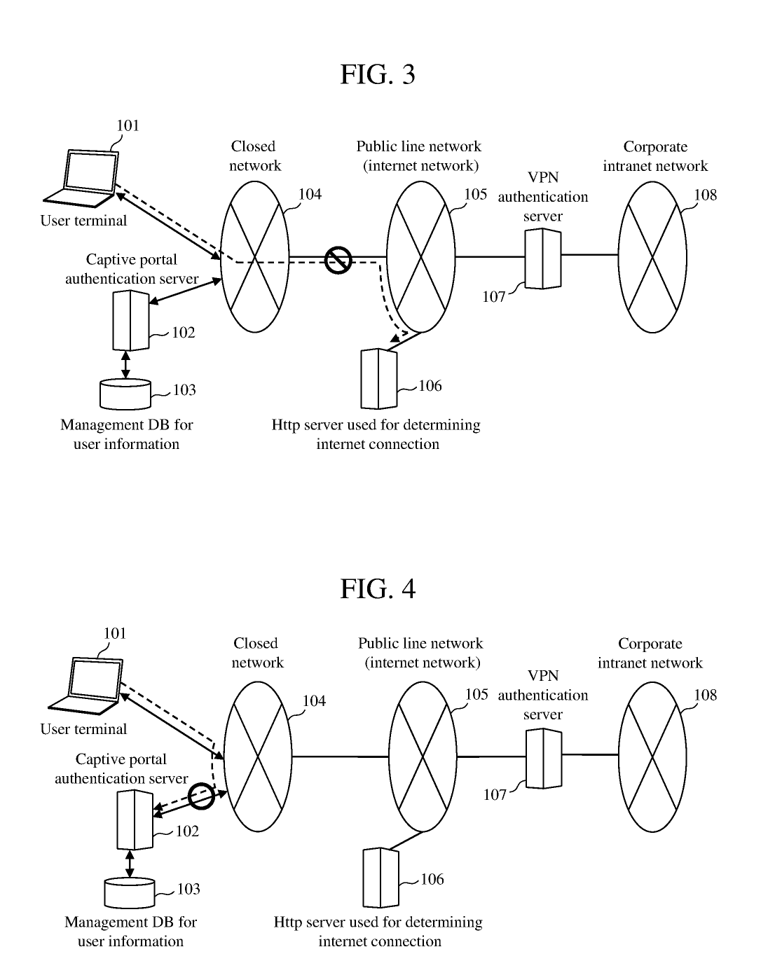

A series of communication patterns associated with captive portal authentication will be described with reference to FIGS. 3 to 6.

### (2-3-1) Before Captive Portal Authentication

FIG. 3 shows a communication pattern before captive portal authentication is performed. Once the user terminal 101 is connected to the closed network 104, the Internet connection status detection unit 201 of the user terminal 101 attempts to communicate with (polls) the HTTP server 106 connected to the public line network 105 at regular intervals, and monitors whether or not communication with the HTTP server 106 is possible. Herein, the Internet connection status detection unit 201 executes transmission of a communication packet addressed to the IP address of the HTTP server 106 that is contained in the address information 301 on the communication destination.

The user terminal 101 cannot communicate with the HTTP server 106 on the Internet unless authentication on a captive portal website has succeeded and communication with the public line network 105 has thus been freed. Thus, the Internet connection status detection unit 201 of the user terminal 101 immediately after it was connected to the closed network 104 cannot receive a response from the HTTP server 106 in reply to polling. At this time, the Internet connection status detection unit 201 determines that the device is not connected to the public line network 105. That is, the Internet connection status detection unit 201 determines that the device has not been authenticated on a captive portal website yet.

While the above determination result is obtained, the Internet connection status detection unit 201 instructs the network connection unit 204 to allow network communication of a browser program. After that, it becomes possible for the user terminal 101 to communicate with a captive portal website that has been redirected by the captive portal authentication server 102, so that authentication becomes possible upon input of information in response to a request from the captive portal website (FIG. 4).

### (2-3-2) Immediately After Captive Portal Authentication

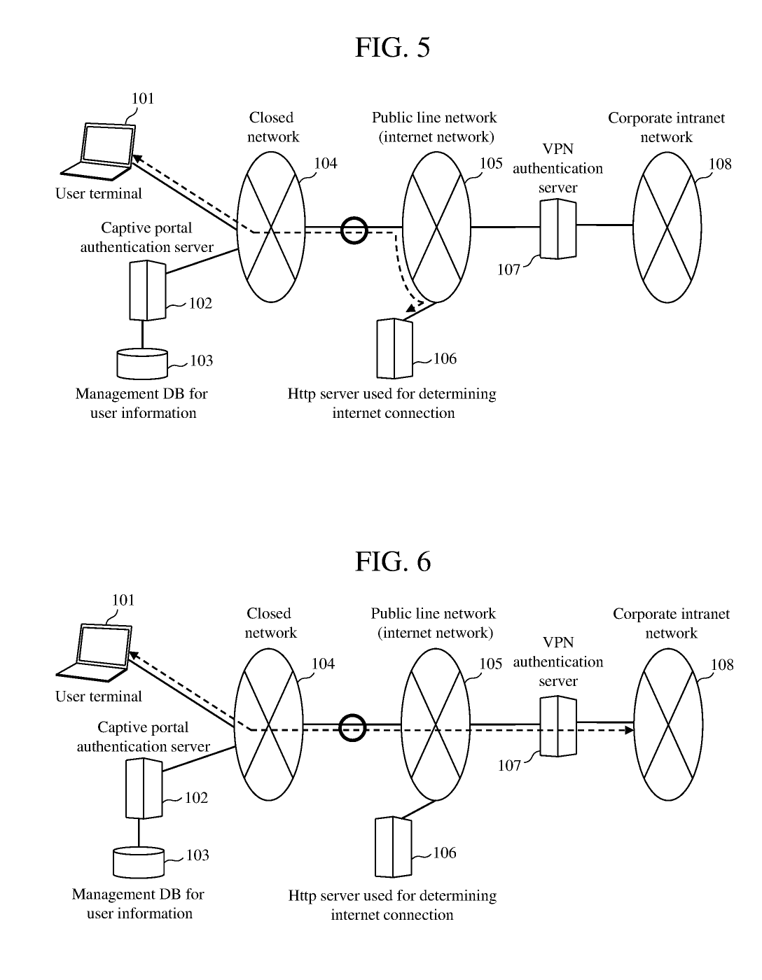

Once authentication on the captive portal website is completed and communication with the public line network 105 is thus freed, it becomes possible for the user terminal 101 to communicate with the HTTP server 106 (FIG. 5). The fact that it has become possible for the user terminal 101 to communicate with the HTTP server 106 is confirmed by receiving, with the Internet connection status detection unit 201, a response in reply to the packet transmitted to the HTTP server 106. Upon confirming the response, the Internet connection status detection unit 201 determines that the terminal is connected to the public line network 105. That is, the Internet connection status detection unit 201 determines that authentication on the captive portal website is complete.

### (2-3-3) After Captive Portal Authentication

Once it is determined that captive portal authentication is complete, the Internet connection status detection unit 201 instructs the network connection unit 204 to prohibit network communication of the browser program. After that, the VPN connection unit 203 realizes VPN communication with the VPN authentication server 107 via the network connection unit 204. It should be noted that communication with IP addresses other than the IP address contained in the policy information 302 is prohibited by the packet filtering unit 202. That is, it becomes possible for the user terminal 101 to communicate with only the VPN authentication server 107 (FIG. 6). Consequently, leakage of information from the user terminal 101 is prevented.

### (2-3-4) After Authentication by VPN Authentication Server

Once authentication of the user terminal 101 by the VPN authentication server 107 is complete, it becomes possible for the user terminal 101 to perform VPN communication with the corporate intranet network 108 via the VPN authentication server 107. Thus, safe communication is realized.

### (2-4) Conclusion

When the communication control function in accordance with this embodiment is mounted on the user terminal 101, it becomes possible to perform captive portal authentication while preventing leakage of information from the terminal to the outside even when a network outside a company, which is constructed in a public space, such as a station or a hotel, uses an access point that complies with a wireless LAN for captive portals. After the captive portal authentication, network communication of the terminal is restricted to communication with the VPN authentication server 107. Thus, safe communication can be realized without the possibility of leakage of information from the terminal to the outside.

With the technique in this embodiment (i.e., a technique of determining whether or not the user terminal 101 is connected to the public line network 105 based on whether or not the user terminal 101 can be connected to the HTTP server 106 (whether or not captive portal authentication is complete)), it is possible to eliminate the need to mount an identifying function, which depends on the format of an unspecified vendor that provides a captive portal website, on the user terminal 101 in advance.

In other words, with the technique in this embodiment, it is possible to perform authentication on a captive portal website with the user terminal 101 in an environment in which network communication of the terminal is restricted to communication with the VPN authentication server 107, without preparing a process of identifying a captive portal website that differs from vendor to vendor. Further, highly safe VPN communication can be realized without the possibility of leakage of information from the user terminal 101 even during authentication on a captive portal website as described above. In addition, with the technique in this embodiment, it is also possible to prevent a user from intentionally leaking information in the user terminal 101 to the Internet.

### (3) Other Embodiments

The present invention is not limited to the aforementioned embodiments, and includes a variety of variations. For example, although the aforementioned embodiments have been described in detail to clearly illustrate the present invention, the present invention need not include all of the configurations described in the embodiments. It is possible to replace a part of a configuration of an embodiment with a configuration of another embodiment. In addition, it is also possible to add, to a configuration of an embodiment, a configuration of another embodiment. Further, it is also possible to, for a part of a configuration of each embodiment, add, remove, or substitute a configuration of another embodiment.

Some or all of the aforementioned configurations, functions, processing units, processing means, and the like may also be implemented as hardware by designing integrated circuits, for example. Alternatively, each of the aforementioned configurations, functions, and the like may be implemented through analysis and execution of a program that implements each function using a processor (in a software manner). Information such as the program that implements each function, tables, and files can be stored in a storage device such as memory, a hard disk, or a SSD (Solid State Drive); or a storage medium such as an IC card, an SD card, or a DVD. Further, the control lines and information lines represent those that are considered to be necessary for the description, and represent not all control lines and information lines that are necessary for a product. In practice, almost all configurations may be considered to be mutually connected.

### DESCRIPTION OF SYMBOLS

101 User terminal
102 Captive portal authentication server
103 Management DB for user information for use in captive portal authentication
104 Closed network
105 Public line network (Internet)
106 HTTP server for determining Internet connection
107 VPN authentication server
108 Corporate intranet network
201 Internet connection status detection unit
202 Packet filtering unit
203 VPN connection unit
204 Network connection unit
301 Address information on communication destination
302 Policy information

What is claimed is:

1. A VPN communication terminal capable of communicating with a VPN authentication server via an Internet, comprising:
a first functional unit configured to autonomously monitor a connection status of the terminal with the Internet;
a second functional unit configured to allow communication of a browser program only when the terminal is not determined to be connected to the Internet by the first functional unit; and
a third functional unit configured to restrict network communication of the terminal to only communication with the VPN authentication server only when the terminal is determined to be connected to the Internet by the first functional unit.

2. The VPN communication terminal according to claim 1, wherein
the first functional unit is configured to
determine that the terminal is connected to the Internet when communication with a specific HTTP server on the Internet is possible, and
determine that the terminal is not connected to the Internet when communication with the specific HTTP server is not confirmed.

3. A communication control method executed by a VPN communication terminal capable of communicating with a VPN authentication server via an Internet, the method comprising the following processes performed by the VPN communication terminal:
autonomously monitoring a connection status of the terminal with the Internet;
allowing communication of a browser program only when the terminal is not determined to be connected to the Internet; and
restricting network communication of the terminal to only communication with the VPN authentication server only when the terminal is determined to be connected to the Internet.

4. A program for causing a computer, which is mounted on a VPN communication terminal capable of communicating with a VPN authentication server via an Internet, to execute the following processes:
autonomously monitoring a connection status of the terminal with the Internet;
allowing communication of a browser program only when the terminal is not determined to be connected to the Internet; and
restricting network communication of the terminal to only communication with the VPN authentication server only when the terminal is determined to be connected to the Internet.
